(19) United States
(12) Patent Application Publication
(10) Pub. No.: US 2012/0247843 A1
(43) Pub. Date: Oct. 4, 2012

(54) INDEPENDENT DUAL WHEEL TRACTOR DRIVE

(75) Inventor: Leo P. Oriet, Rochester Hills, MI (US)

(73) Assignee: NAVISTAR CANADA, INC., Lisle, IL (US)

(21) Appl. No.: 13/508,906

(22) PCT Filed: Nov. 24, 2009
(86) PCT No.: PCT/US2009/065715

§ 371 Date: Jun. 7, 2012

(51) Int. Cl. B60K 7/00

(52) U.S. Cl. 180/55; 301/6.5

(57) ABSTRACT

A casing has an inner end, an outer end, and an internal drive mechanism. The internal drive mechanism has an outer wheel mounting hub at the outer end of the casing and an inner wheel mounting hub at the inner end of the casing, both supported for rotation about an axis. A motor operates the internal drive mechanism to impart rotation to the wheel mounting hubs with equal force whilst allowing the wheel mounting hubs to rotate at different speeds. The internal drive mechanism further has a carrier that is disposed between the inner wheel mounting hub and the outer wheel mounting hub and that is rotated about the axis by the motor. The carrier contains a differential gear mechanism having an outer output shaft for imparting rotation to the outer wheel mounting hub and an inner output shaft for imparting rotation to the inner wheel mounting hub.

### TECHNICAL FIELD

This disclosure relates to an independent dual wheel drive for a large motor vehicle such as a highway tractor.

### BACKGROUND OF THE DISCLOSURE

The axle configuration of a commercial motor vehicle, such as a highway tractor or other large truck vehicle, or a construction, mining, military, or agricultural tractor or implement, is sometimes designated by the total number of points of contact with an underlying surface followed by the number of those points of contact that are powered. Examples of such axle configurations are 4×2, 6×2, and 6×4, as shown in FIG. 1A where the axle with a large dot at the center designates a drive axle. A drive axle whose wheels are powered may have a single right wheel and a single left wheel, or it may have dual right wheels and dual left wheels. The latter is sometimes referred to as a dual wheel axle. While pneumatic tires mounted on wheels of a dual wheel axle provide four discrete points of contact with an underlying surface, such an axle is considered to have only two points of contact when designating the axle configuration of a vehicle containing such an axle.

In one type of dual wheel axle whose wheels are driven, the wheels of each pair are mechanically coupled together to rotate in unison. Torque for rotating each pair is delivered through a differential gear mechanism from a prime mover such as an internal combustion engine, electric motor, hydraulic motor, or hybrid coupled to the differential mechanism through a drivetrain.

When the vehicle is making turns, the tires on each pair of wheels are subject to increased rolling resistance and wear, and the axle mechanism is subject to binding. This is because each of the four tires is turning about a different radius of curvature at the same time that the mechanical coupling of the wheels of each pair is forcing the two tires of the pair to rotate in unison. Undeniable evidence of this effect can be seen from rear tire skid marks that such an axle makes on pavement when the vehicle is turning This is a long-standing issue that remains unresolved to this day. Cumulative effects of such vehicles turning on a piece of pavement such as at a street intersection may lead to structural fractures in the pavement. This is one of various justifications used by government to charge high fees for truck licensing. This type of axle may also provoke vehicle understeer because of increased resistance to turning that requires more turning force to be exerted by the driver.

Certain attributes of a drive axle that has “super single” tires are considered by some to make such an axle a better alternative to a dual wheel drive axle but super singles are not immune from leaving scuff marks on pavement.

It is believed that a preponderance of fleet owners and owner operators prefer conventional dual wheel axles to super singles because the former tend to have longer tread life and they reduce roadside downtime because of flat tires.

An independent dual wheel drive allows either of the dual wheels on each side of the vehicle to rotate at a different speed from the speed at which the other wheel rotates. An example of an independent dual wheel drive axle that employs a respective differential gear mechanism between the wheels of each pair is disclosed in U.S. Pat. No. 2,126,960, the disclosure of which is incorporated herein in its entirety by this reference. That patent refers to those differentials as secondary differentials because its axle also has a primary differential as a third differential through which the engine and drivetrain are coupled to wheels on each side.

### SUMMARY OF THE DISCLOSURE

The present disclosure relates to a vehicle comprising a chassis having a left side and a right side, an outer left road wheel assembly on the left side of the chassis and inner left road wheel assembly on the left side of the chassis inboard of the outer left road wheel assembly, an outer right road wheel assembly on the right side of the chassis and inner right road wheel assembly on the right side of the chassis inboard of the outer right road wheel assembly, a left drive unit for driving the outer left road wheel assembly and the inner left road wheel assembly, a right drive unit for driving the outer right road wheel assembly and the inner right road wheel assembly, each drive unit comprising a respective carrier, a respective differential gear mechanism carried by the respective carrier, and a respective motor for rotating the respective carrier about a respective axis, each differential gear mechanism comprising a respective first spider gear on a respective first output shaft, a respective second spider gear on a respective second output shaft, a respective third spider gear, and a respective fourth spider gear, each third spider gear being meshed with both the first spider gear and the second spider gear of the respective differential gear mechanism, each fourth spider gear being meshed with both the first spider gear and the second spider gear of the respective differential gear mechanism, each third spider gear being freely rotatable on a respective first mounting shaft that is affixed to and rotates bodily with the respective carrier, each fourth spider gear being freely rotatable on a respective second mounting shaft that is affixed to and rotates bodily with the respective carrier, each drive unit comprising a respective outer gear train coupling the respective outer output shaft with the respective outer road wheel assembly and a respective inner gear train coupling the respective inner output shaft with the respective inner road wheel assembly.

The present disclosure also relates to an independent dual wheel tractor drive unit comprising a casing having an inner end, an outer end, and an internal drive mechanism, the internal drive mechanism comprising an inner wheel mounting hub at the inner end of the casing and an outer wheel mounting hub at the outer end of the casing, both of which wheel mounting hubs are supported for rotation about an axis, a motor for operating the internal drive mechanism to impart rotation to the wheel mounting hubs with equal force whilst allowing the wheel mounting hubs to rotate at different speeds, the internal drive mechanism further comprising a carrier that is disposed between the inner wheel mounting hub and the outer wheel mounting hub and that is rotated about the axis by the motor, and the carrier containing a differential gear mechanism having an inner output shaft for imparting rotation to the inner wheel mounting hub and an outer output shaft for imparting rotation to the outer wheel mounting hub.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a diagram depicting a top view of a portion of a first embodiment of a chassis frame of a wheeled vehicle, with FIG. 1A being an explanatory diagram showing several examples of different axle configurations for wheeled vehicles.

FIG. 2 is a diagram depicting a top view of a portion of a second embodiment of a chassis frame of a wheeled vehicle.

FIG. 3 is a diagram showing a rear elevation view of a portion of FIG. 1 on a larger scale.

FIG. 4 is an enlarged view in vertical cross section of a portion of FIG. 3.

FIG. 5 is an exploded view of a portion of FIG. 4.

FIG. 6 is an exploded view showing an additional portion of FIG. 4.

FIG. 7 is a perspective view, partly in cross section and partly exploded, of a portion of FIG. 4 on a larger scale.

FIG. 8 is a perspective view, partly in cross section, of a portion of FIG. 4 on a larger scale.

FIG. 9 is an enlarged cross section view taken in the general direction of arrows 9-9 in FIG. 4.

FIG. 10 is an enlarged view of a portion of FIG. 4.

FIG. 11 is a fragmentary view of a portion of FIG. 10 at a right angle to the view of FIG. 10.

FIG. 12 is a side elevation view, partly in cross section, of a portion of FIG. 1 on a larger scale.

FIG. 13 is a side elevation view, partly in cross section, of a portion of FIG. 2 on a larger scale.

### DETAILED DESCRIPTION

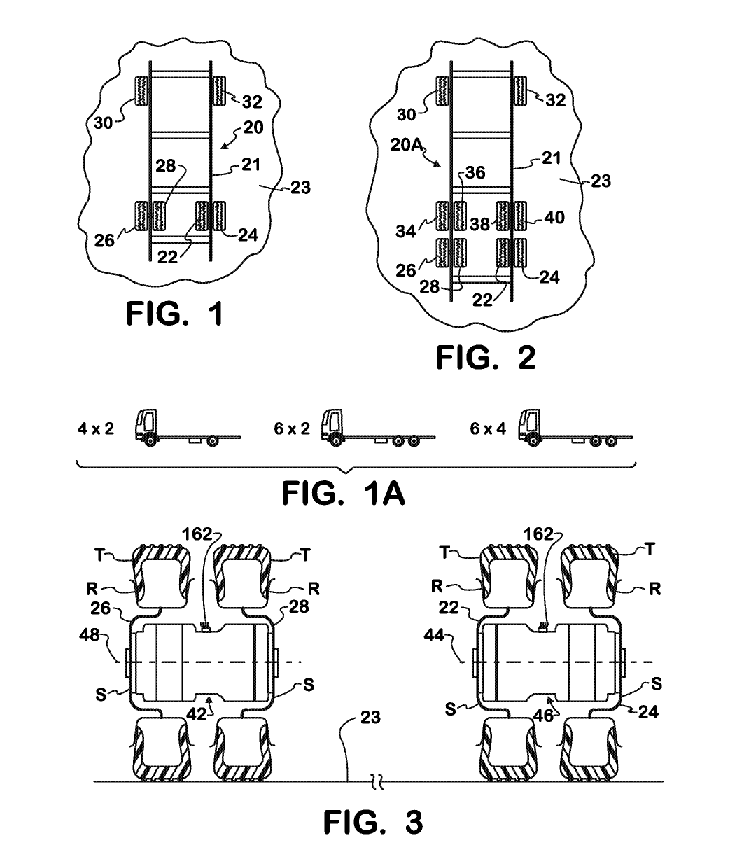

A chassis 20 of a vehicle comprises a chassis frame 21 shown in FIG. 1 and supported for travel on an underlying surface 23 by an outer left rear road wheel assembly 26, an inner left rear road wheel assembly 28 that is inboard of outer left rear road wheel assembly 26, an outer right rear road wheel assembly 24, an inner right rear road wheel assembly 22 that is inboard of outer right rear road wheel 24, a left front road wheel assembly 30, and a right front road wheel assembly 32.

Left front road wheel assembly 30 is on a left side of chassis 20 toward a front of chassis frame 21. Right front road wheel assembly 32 is on a right side of chassis 20 toward the front of chassis frame 21, opposite left front road wheel assembly 30. A steering system (not shown) can turn left front road wheel assembly 30 and right front road wheel assembly 32 in unison to steer chassis 20 in a direction of travel.

Outer left rear road wheel assembly 26 and inner left rear road wheel assembly 28 are driven by a left drive unit 42 shown in FIG. 3. Collectively, outer left rear road wheel assembly 26, inner left rear road wheel assembly 28, and left drive unit 42 form a left rear independent dual wheel drive for chassis 20.

Inner right rear road wheel assembly 22 and outer right rear road wheel assembly 24 are driven by a right drive unit 46 shown in FIG. 3. Collectively, inner right rear road wheel assembly 22, outer right rear road wheel assembly 24, and right drive unit 46 form a right rear independent dual wheel drive for chassis 20.

FIG. 2 shows a chassis 20A which is like chassis 20 but to which has been added an outer left rear tandem road wheel assembly 34, an inner left rear tandem road wheel assembly 36, an inner right rear tandem road wheel assembly 38, and an outer right rear tandem road wheel assembly 40.

Outer left rear tandem road wheel assembly 34 is in tandem with outer left rear road wheel assembly 26, and inner left rear tandem road wheel assembly 36 is in tandem with inner left rear road wheel assembly 28. Outer left rear tandem road wheel assembly 34 and inner left rear tandem road wheel assembly 36 are driven by a left tandem drive unit (not shown) that is like left drive unit 42, and the three collectively form a left rear tandem independent dual wheel drive for chassis 20A forward of the left rear independent dual wheel drive formed by outer left rear road wheel assembly 26, inner left rear road wheel assembly 28, and left drive unit 42.

Inner right rear tandem road wheel assembly 38 is in tandem with inner right rear road wheel assembly 22, and outer right rear tandem road wheel assembly 40 is in tandem with outer right rear road wheel assembly 24. Inner right rear tandem road wheel assembly 38 and outer right rear tandem road wheel assembly 40 are driven by a right tandem drive unit (not shown) that is like drive unit 46, and the three collectively form a right rear tandem independent dual wheel drive for chassis 20A forward of the right rear independent dual wheel drive formed by inner right rear road wheel assembly 22, outer right rear road wheel assembly 24, and right drive unit 46.

As shown in FIG. 3, left drive unit 42 rotates outer left rear road wheel assembly 26 and inner left rear road wheel assembly 28 about an axis 44, and right drive unit 46 rotates inner right rear road wheel assembly 22 and outer right rear road wheel assembly 24 about an axis 48 that is coincident with axis 44.

FIG. 3 further shows each of outer left rear road wheel assembly 26, inner left rear road wheel assembly 28, inner right road wheel assembly 22, and outer right rear road wheel assembly 24 to comprise a central wheel spider S and a circular rim R on which a pneumatic tire T is mounted.

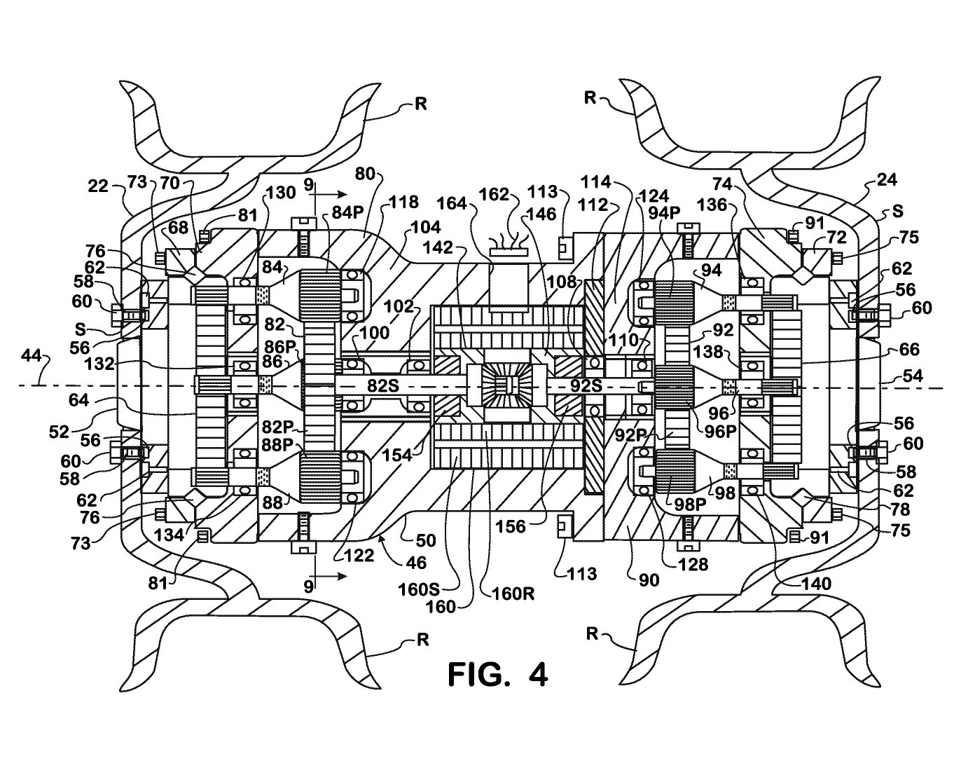

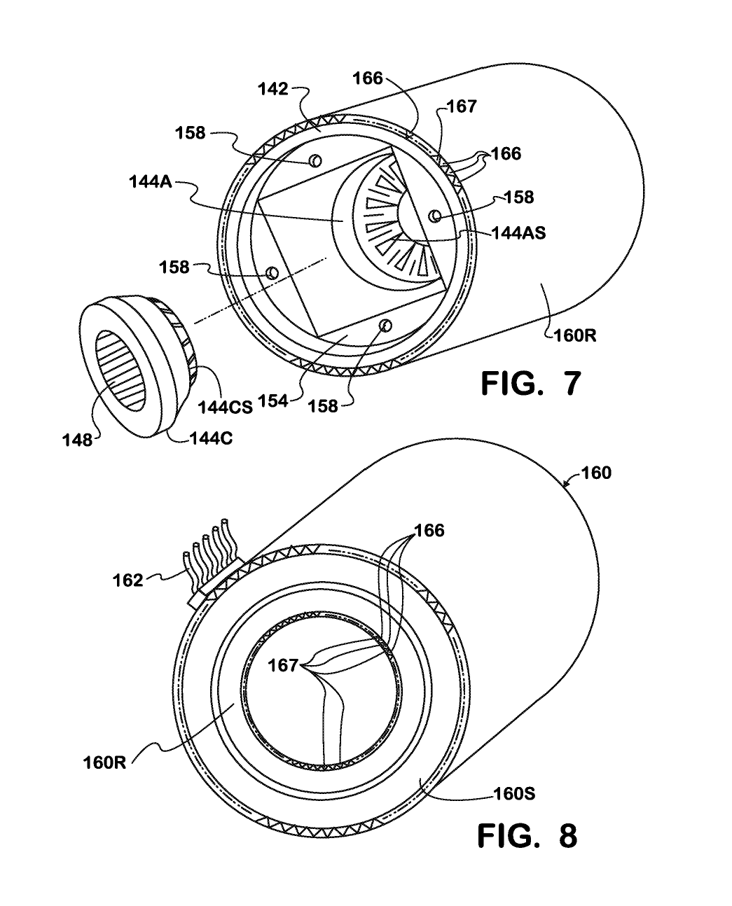

As shown in, and as will be described with reference to, FIGS. 4-11, right drive unit 46 comprises a multi-part casing 50 that houses a right drive mechanism. Right drive mechanism of right drive unit 46 comprises an outer wheel mounting hub 54 at a laterally outer end of multi-part casing 50 relative to chassis frame 21 and an inner wheel mounting hub 52 at a laterally inner end of multi-part casing 50 relative to chassis frame 21, both of which wheel mounting hubs are arranged to rotate about axis 44. Multi-part casing 50 and its internal drive mechanism have a construction allowing use either as a right drive unit 46 or as a left drive unit 42. By using an independent drive unit like 42 and 46 for driving the dual rear road wheel assemblies on each side of chassis 20 in a vehicle that appears outwardly to have a 4×2 axle configuration, such a vehicle may be considered to have a 6×4 axle consideration due to how each drive unit drives its two road wheel assemblies.

The central wheel spider S of outer right rear road wheel assembly 24 is disposed against and fastened to a portion of an external face of outer wheel mounting hub 54, and the central wheel spider S of inner right rear road wheel assembly 22 is disposed against and fastened to a portion of an external face of inner wheel mounting hub 52.

The central wheel spider S of outer right rear road wheel assembly 24 is located to outer wheel mounting hub 54 via threaded mounting studs 56 that are arranged in a circular pattern about axis 44 to extend from the external face of outer wheel mounting hub 54 through through-holes 58 in the central wheel spider S of outer right rear road wheel assembly 24. After through-holes 58 have been registered with threaded mounting studs 56 of outer wheel mounting hub 54 and the central wheel spider S of outer right rear road wheel assembly 24 has been pushed against the external face of outer wheel mounting hub 54, wheel nuts 60 are threaded onto the free ends of threaded mounting studs 56 and tightened against the central wheel spider S to keep the latter fast against the external face of outer wheel mounting hub 54.

The central wheel spider S of inner right rear road wheel assembly 22 is located to inner wheel mounting hub 52 via threaded mounting studs 56 that are arranged in a circular pattern about axis 44 to extend from the external face of inner wheel mounting hub 52 through through-holes 58 in the central wheel spider S of inner right rear road wheel assembly 22. After through-holes 58 have been registered with threaded mounting studs 56 of inner wheel mounting hub 52 and the central wheel spider S of inner right rear road wheel assembly 22 has been pushed against the external face of inner wheel mounting hub 52, threaded wheel nuts 60 are threaded onto the free ends of threaded mounting studs 56 and tightened against the central wheel spider S to keep the latter fast against the external face of inner wheel mounting hub 52.

An outer ring gear 66 is disposed against an outer circumferential margin of an inner face of outer wheel mounting hub 54 and is fastened to outer wheel mounting hub 54 by fasteners 62 so that the two are coupled for rotation in unison coaxially about axis 44 within an outer ring gear case of multi-part casing 50.

An inner ring gear 64 is disposed against an outer circumferential margin of an inner face of inner wheel mounting hub 52 and is fastened to inner wheel mounting hub 52 by fasteners 62 so that the two are coupled for rotation in unison coaxially about axis 44 within an inner ring gear case of multi-part casing 50.

Multi-part casing 50 comprises several casing parts fastened together. An end face of a first casing part 68 is disposed against a circular margin of an end face of a second casing part 70, and the two are fastened together by screws 73 to cooperatively form the inner ring gear case for inner ring gear 64. An end face of a third casing part 72 is disposed against a circular margin of an end face of a fourth casing part 74, and the two are fastened together by screws 75 to cooperatively form the outer ring gear case for outer ring gear 66.

First casing part 68 and second casing part 70 comprise features for enabling inner ring gear 64 to be supported for rotation about axis 44 via an inner main bearing assembly 76. Third casing part 72 and fourth casing part 74 comprise features for enabling outer ring gear 66 to be supported for rotation about axis 44 via an outer main bearing assembly 78, details of which will be described later.

Second casing part 70 and a fifth casing part 80 are fastened together by screws 81 to cooperatively form an inner sun-planet gear case for an inner gear train comprising, in addition to inner ring gear 64, an inner sun gear 82, a first inner planet gear 84, a second inner planet gear 86, and a third inner planet gear 88.

Fourth casing part 74 and a sixth casing part 90 are fastened together by screws 91 to cooperatively form an outer sun-planet gear case for an outer gear train comprising, in addition to outer ring gear 66, an outer sun gear 92, a first outer planet gear 94, a second outer planet gear 96, and a third outer planet gear 98.

Inner sun gear 82 comprises an inner sun gear pinion 82P that is supported on an inner sun gear shaft 82S whose axis is coincident with axis 44. From inner sun gear pinion 82P, inner sun gear shaft 82S extends axially inward of multi-part casing 50 to be supported for rotation about axis 44 by a first ball- or roller-bearing assembly 100 that is disposed in a cage, or counterbore, in a face of a transverse wall 104 of fifth casing part 80 toward the inner sun-planet gear case and by a second ball- or roller-bearing assembly 102 that is disposed in a cage, or counterbore, in an opposite face of transverse wall 104.

Outer sun gear 92 comprises an outer sun gear pinion 92P that is supported on an outer sun gear shaft 92S whose axis is coincident with axis 44. From outer sun gear pinion 92P, outer sun gear shaft 92S extends axially inward of multi-part casing 50 to be supported for rotation about axis 44 by a third ball- or roller-bearing assembly 108 that is disposed in a cage, or counterbore, in a circular plate, or cover, 112 that is fit to a counterbore in a face of fifth casing part 80 whose outer circumferential margin is disposed against an outer circumferential margin of a face of sixth casing part 90 where fifth casing part 80 and sixth casing part 90 are fastened together by screws 113. Circular plate, or cover, 112 is fastened to fifth casing part 80 by screws 116 and may be considered as an internal casing part. Outer sun gear shaft 92S is also supported for rotation about axis 44 by a fourth ball- or roller-bearing assembly 110 that is disposed in a cage, or counterbore, in a face of transverse wall 114 that is toward the outer sun-planet gear case.

First inner planet gear 84 comprises a first inner planet gear pinion 84P in mesh with inner sun gear pinion 82P and a first inner planet shaft 84S that extends in opposite axial directions from first inner planet gear pinion 84P. An inner end of first inner planet shaft 84S is received in a first inner planet bearing assembly 118.

Second inner planet gear 86 comprises a second inner planet gear pinion 86P in mesh with inner sun gear pinion 82P and a second inner planet shaft 86S that extends in opposite axial directions from second inner planet gear pinion 86P. An inner end of second inner planet shaft 86S is received in a second inner planet bearing assembly 120.

Third inner planet gear 88 comprises a third inner planet gear pinion 88P in mesh with inner sun gear pinion 82P and a third inner planet shaft 88S that extends in opposite axial directions from third inner planet gear pinion 88P. An inner end of third inner planet shaft 88S is received in a third inner planet bearing assembly 122.

First outer planet gear 94 comprises a first outer planet gear pinion 94P in mesh with outer sun gear pinion 92P and a first outer planet shaft 94S that extends in opposite axial directions from first outer planet gear pinion 94P. An inner end of first outer planet shaft 94S is received in a first outer planet bearing assembly 124.

Second outer planet gear 96 comprises a second outer planet gear pinion 96P in mesh with outer sun gear pinion 92P and a second outer planet shaft 96S that extends in opposite axial directions from second outer planet gear pinion 96P. An inner end of second outer planet shaft 96S is received in a second outer planet bearing assembly 126.

Third outer planet gear 98 comprises a third outer planet gear pinion 98P in mesh with outer sun gear pinion 92P and a third outer planet shaft 98S that extends in opposite axial directions from third outer planet gear pinion 98P. An inner end of third outer planet shaft 98S is received in a third outer planet bearing assembly 128.

First inner planet bearing assembly 118, second inner planet bearing assembly 120, and third inner planet bearing assembly 122 are caged in a face of transverse wall 104 bounding the inner sun/planet gear case containing inner sun gear 82. First outer planet bearing assembly 124, second outer planet bearing assembly 126, and third outer planet bearing assembly 128 are caged in a face of transverse wall 114 bounding the outer sun/planet gear case containing outer sun gear 92.

The left hand end portion of first inner planet shaft 84S comprises a fourth inner planet gear pinion 84X that is in mesh with inner ring gear 64. Between the first inner planet gear pinion 84P and the fourth inner planet gear pinion 84X, first inner planet shaft 84S is received in and supported for rotation by a fourth inner planet bearing assembly 130.

The left hand end portion of second inner planet shaft 86S comprises a fifth inner planet gear pinion 86X that is in mesh with inner ring gear 64. Between the second inner planet gear pinion 86P and the fifth inner planet gear pinion 86X, second inner planet shaft 86S is received in and supported for rotation by a fifth inner planet bearing assembly 132.

The left hand end portion of third inner planet shaft 88S comprises a sixth inner planet gear pinion 88X that is in mesh with inner ring gear 64. Between the third inner planet gear pinion 88P and the sixth inner planet gear pinion 88X, third inner planet shaft 88S is received in and supported for rotation by a sixth inner planet bearing assembly 134.

The right hand end portion of first outer planet shaft 94S comprises a fourth outer planet gear pinion 94X that is in mesh with outer ring gear 66. Between the first outer planet gear pinion 94P and the fourth outer planet gear pinion 94X, first outer planet shaft 94S is received in and supported for rotation by a fourth outer planet bearing assembly 136.

The right hand end portion of second outer planet shaft 96S comprises a fifth outer planet gear pinion 96X that is in mesh with outer ring gear 66. Between the second outer planet gear pinion 96P and the fifth outer planet gear pinion 96X, second outer planet shaft 96S is received in and supported for rotation by a fifth outer planet bearing assembly 138.

The right hand end portion of third outer planet shaft 98S comprises a sixth outer planet gear pinion 98X that is in mesh with outer ring gear 66. Between the third outer planet gear pinion 98P and the sixth outer planet gear pinion 98X, third outer planet shaft 98S is received in and supported for rotation by a sixth outer planet bearing assembly 140.

Fourth inner planet bearing assembly 130, fifth inner planet bearing assembly 132, and sixth inner planet bearing assembly 134 are caged in the face of second casing part 70 that bounds the inner sun/planet gear case containing inner sun gear 82. Fourth inner planet bearing assembly 136, fifth inner planet bearing assembly 138, and sixth inner planet bearing assembly 140 are caged in the face of fourth casing part 74 that bounds the outer sun/planet gear case containing outer sun gear 92.

At this point in the description, it can be explained that rotation of inner sun gear shaft 82S causes inner sun gear pinion 82P to rotate about axis 44 and impart rotary motion to first inner planet gear 84, second inner planet gear 86, and third inner planet gear 88. FIG. 9 shows first inner planet gear 84, second inner planet gear 86, and third inner planet gear 88 centered at 120° intervals about axis 44. As the three inner planet gears 84, 86, and 88 rotate in synchronism with rotation of inner sun gear 82, they collectively act to rotate inner ring gear 64, and hence inner wheel mounting hub 52 and inner right rear road wheel assembly 22. Because the inner planet gears 84, 86, 88 do not orbit the inner sun gear 82, the inner planet gears 84, 86, 88 do not planetate as inner sun gear 82 rotates, but they are nonetheless referred to as planet gears because they appear as a non-orbiting arrangement of planets about a sun, as in FIG. 9.

Likewise, rotation of outer sun gear shaft 92S causes outer sun gear pinion 92P to rotate about axis 44 and impart rotary motion to first outer planet gear 94, second outer planet gear 96, and third outer planet gear 98. The three outer planet gears 94, 96, 98 are centered at 120° intervals about axis 44 and rotate in synchronism with rotation of outer sun gear 92 to collectively act in rotating outer ring gear 66, and hence outer wheel mounting hub 54 and outer right rear road wheel assembly 24. Because the outer planet gears 94, 96, 98 do not orbit the outer sun gear 92, the outer planet gears 94, 96, 98 do not planetate as outer sun gear 92 rotates, but they are nonetheless referred to as planet gears because they appear as a non-orbiting arrangement of planets about a sun.

Rotation is imparted to inner sun gear shaft 82S and to outer sun gear shaft 92S by a spider cage assembly 142 that is supported for rotation about axis 44 and that contains a differential gear mechanism 144. Spider cage assembly 142 comprises a cage 146 having a tubular cylindrical shape whose axis is coincident with axis 44. Cage 146 is a carrier of differential gear mechanism 144.

Differential gear mechanism 144 comprises a first spider gear element 144A, a second spider gear element 144B, a third spider gear element 144C, and a fourth spider gear element 144D. A respective external gear formation 144AS, 144BS, 144CS, and 144DS of each respective spider gear element 144A, 144B, 144C, and 144D meshes with the external gear formation of the two adjacent spider gear elements.

First spider gear element 144A is disposed, and is free to rotate, on a first spider mounting shaft 145. Second spider gear element 144B is disposed, and is free to rotate, on a second spider mounting shaft 147. Spider mounting shafts 145, 147 are arranged diametrically opposite each other about axis 44 with their axes aligned and perpendicular to axis 44. The far ends of spider mounting shafts 145, 147 relative to axis 44 are affixed to cage 146 so that the shafts bodily rotate with cage 146. Consequently as spider cage assembly 142 rotates about axis 44, spider gear elements 144A, 144B bodily revolve with cage 146 while each is free to rotate about the respective spider mounting shaft 145, 147 on which it is disposed.

Third spider gear element 144C has a hole that comprises an internal spline through-hole 148 that fits to an external spline 150 on an end of inner sun gear shaft 82S thereby coupling inner sun gear 82 for rotation with third spider gear element 144C. Fourth spider gear element 144D has a hole that comprises an internal spline 148 that fits to an external spline 150 on an end of outer sun gear shaft 92S thereby coupling outer sun gear 92 for rotation with fourth spider gear element 144D. Retaining ring clips 152 are placed in grooves in inner sun gear shaft 82S and outer sun gear shaft 92S to axially capture third spider gear element 144C and fourth spider gear element 144D after the latter two have been placed on the respective shafts. Inner sun gear shaft 82S and outer sun gear shaft 92S form first and second output shafts of differential gear mechanism 144.

Spider cage assembly 142 further comprises end closures 154, 156 that are fastened by screws 158 to opposite axial ends of cage 146. Each end closure 154, 156 has a respective through-hole that allows the respective sun gear shaft 82S, 92S to pass through from the exterior of the cage to the respective spider gear element 144C, 144D.

Spider cage assembly 142 is rotated about axis 44 by an electric motor 160 that comprises a stator 160S and a rotor 160R. Electric motor 160 is housed within fifth casing part 80 between transverse wall 104 and circular plate, or cover, 112. Electrical connections 162 for connecting stator 160S to an external power source pass through a hole 164 in a side wall of fifth casing part 80.

Stator 160S circumferentially surrounds rotor 160R, and the latter is supported for rotation internally of electric motor 160. Rotation of rotor 160R is coupled to spider cage assembly 142 by a spline coupling that comprises an internal spline 166 on the inner diameter of rotor 160R (suitably electrically insulated from the motor) and an external spline 167 on cage 146.

Electric motor 160 is bi-directional and when it operates to rotate spider cage assembly 142 in either a forward sense or a reverse sense, differential gear mechanism 144 is effective to couple the cage rotation to sun gear shafts 82S, 92S, thereby rotating inner right rear road wheel assembly 22 and outer right rear road wheel assembly 24. In doing so, differential gear mechanism 144 allows one sun gear shaft to rotate at a different speed from the other sun gear shaft when front road wheel assemblies 30, 32 are operated to steer chassis 20 from straight line travel to curved line travel. In this way binding, scuffing, and understeering are significantly mitigated in comparison to conventional dual wheel axles in which the dual wheels at each end of the axle are forced to rotate in unison.

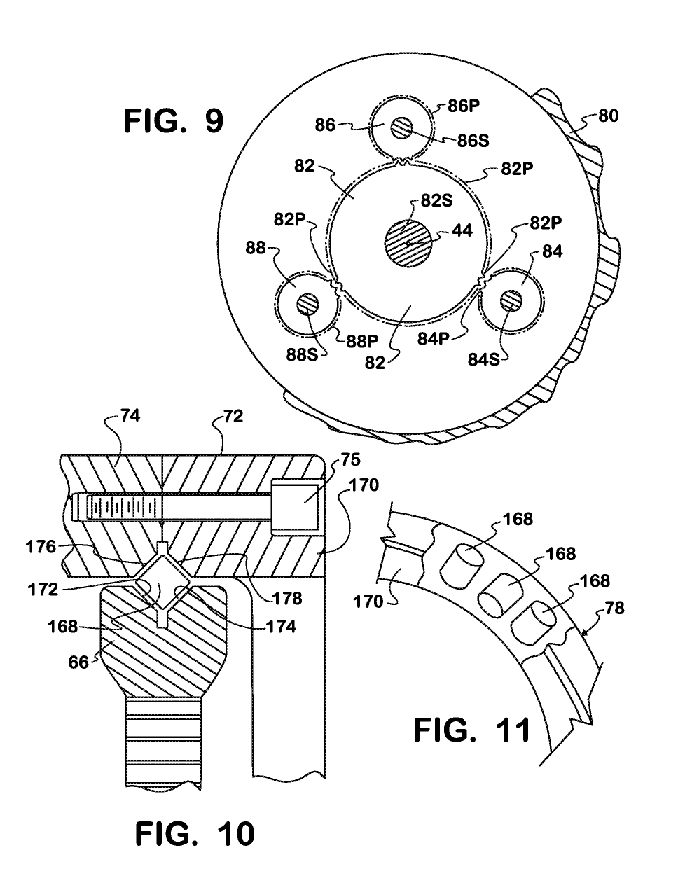

FIGS. 10 and 11 show main bearing assembly 78 to comprise a number of cylindrical rollers 168 that are caged in a bearing retainer 170 that has apertures allowing the cylindrical rollers to roll on surfaces of third casing part 72 and fourth casing part 74 and opposite surfaces of inner ring gear 64.

The outer circumference of outer ring gear 66 has a V-groove comprising side surfaces 172, 174 that are at a right angle to each other. A 45° chamfered surface 176 extends circumferentially around fourth casing part 74 radially outward of side surface 172 relative to axis 44. A 45° chamfered surface 178 extends circumferentially around third casing part 72 radially outward of side surface 174 relative to axis 44.

While cylindrical rollers 168 are identical in size, they are individually arranged in bearing retainer 170 in one of two different ways. One way is with the rolling surface rolling on side surface 172 and the opposite 45° chamfered surface 178. The other way is with the rolling surface rolling on side surface 174 and the opposite 45° chamfered surface 176. These two ways in which the individual rollers roll alternate around the circumference of main bearing assembly 78.

Main bearing assembly 76 has a like construction and similar association with respect to inner ring gear 64 and first and second casing parts 68, 70.

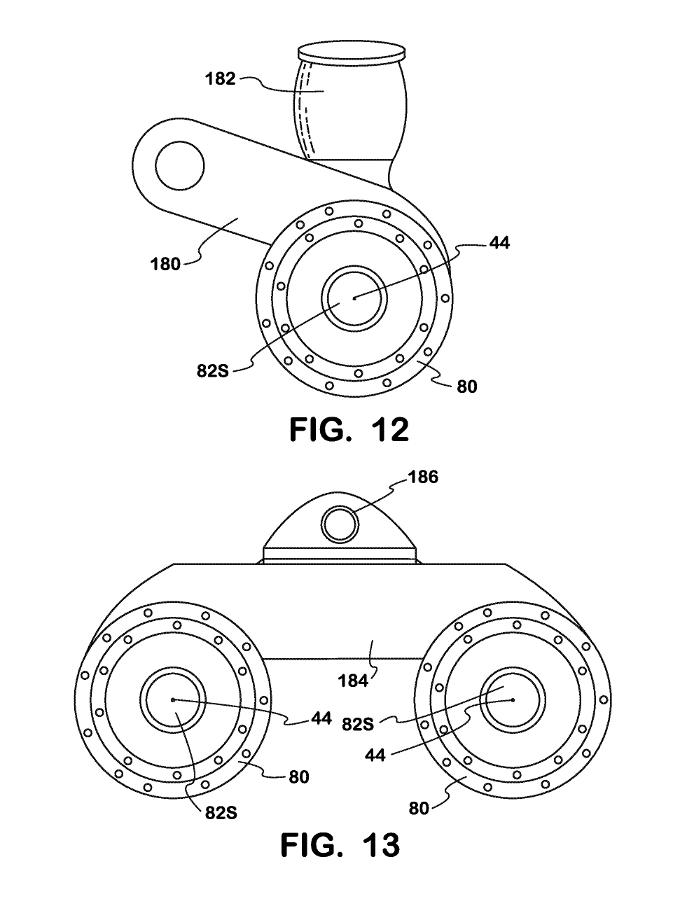

FIG. 12 shows a trailing arm suspension of a right drive unit 46. The forward end of a trailing arm 180 (or alternately a rear end of a leading arm) is bushing-mounted in chassis frame 21. An air spring 182 is disposed between chassis frame 21 and right drive unit 46.

A similar arrangement suspends left drive unit 42. Left drive unit 42 has a left drive mechanism that would appear symmetrically opposite to that of right drive unit 46 that has been described here in detail. Hence a detailed description of the left drive mechanism of left drive unit 42 is considered unnecessary.

FIG. 13 shows a walking beam suspension tandem mounting for inner right rear road wheel assembly 22, outer right rear road wheel assembly 24, inner right rear tandem road wheel assembly 38, and outer right rear tandem road wheel assembly 40 in which inner right rear road wheel assembly 22 and outer right rear road wheel assembly 24 are driven by right drive unit 46. Inner right rear tandem road wheel assembly 38 and outer right rear tandem road wheel assembly 40 are driven by their own right tandem drive unit that is like right drive unit 46. The walking beam comprises a carriage 184 that is bushing-mounted in chassis frame 21 of FIG. 2 via a pivot 186 located between the front pair of road wheel assemblies comprising inner right rear tandem road wheel assembly 38 and outer right rear tandem road wheel assembly 40 and the rear pair of road wheel assemblies comprising inner right rear road wheel assembly 22 and outer right rear road wheel assembly 24. Suspension springs are not shown.

A similar walking beam suspension tandem mounting is present on the left side of chassis 20A for outer left rear road wheel assembly 26, inner left rear road wheel assembly 28, outer left rear tandem road wheel assembly 34, and inner left rear tandem road wheel assembly 36. Hence, the propulsion system for a “tandem axle drive” vehicle that contains chassis 20A shown in FIG. 2 comprises a total of four independent drive units each propelling a respective inner road wheel assembly and a respective outer road wheel assembly.

With drive units 42, 46 installed in a vehicle as described, service access to spider cage assembly 142, differential gear mechanism 144, electric motor 160, and the outer gear train is convenient. Each drive unit can remain suspended from the chassis frame while vehicle weight is supported by the inner road wheel assembly after the outer road wheel assembly has been removed. Third casing part 72, fourth casing part 74, and sixth casing part 90 can be successively unfastened and disassembled in that order as necessary. This capability allows efficient maintenance and service access that may avoid having to jack up the truck and/or remove other parts.

The disclosure provides a drive for independent dual wheels at each side of a vehicle. The drive and wheels are organized as a unit that can be independently suspended from a chassis frame. Such an arrangement can provide improve ride and handling to a large truck or bus, or other vehicles, in various driving situations including on-road and off-road driving. In a vehicle having a chassis configuration like that shown in FIG. 1, the ability to rotate right rear road wheels 22, 24 in one direction using the motor of right drive unit 46 while simultaneously rotating left rear road wheels 26, 28 in the opposite direction can enable a vehicle having a suitable front axle to make a zero radius turn thereby endowing such a vehicle with maneuverability in confined spaces.

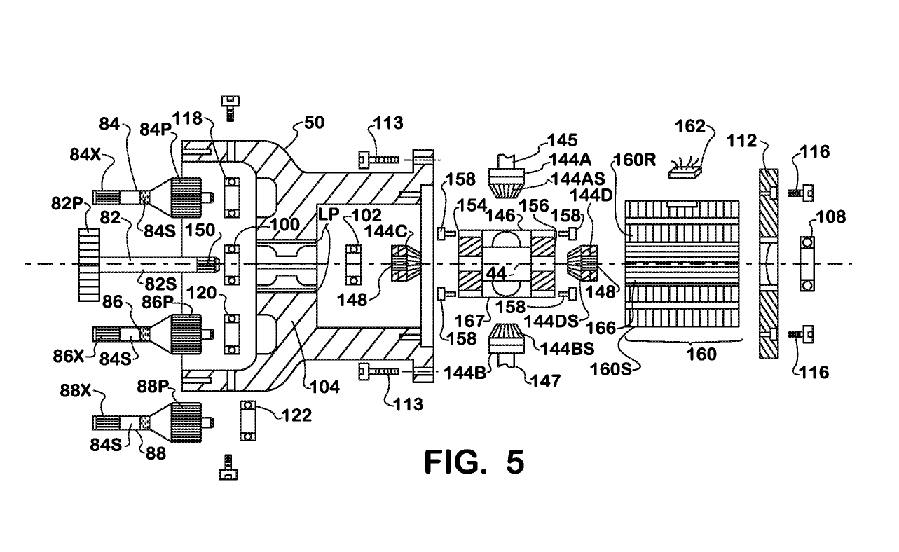

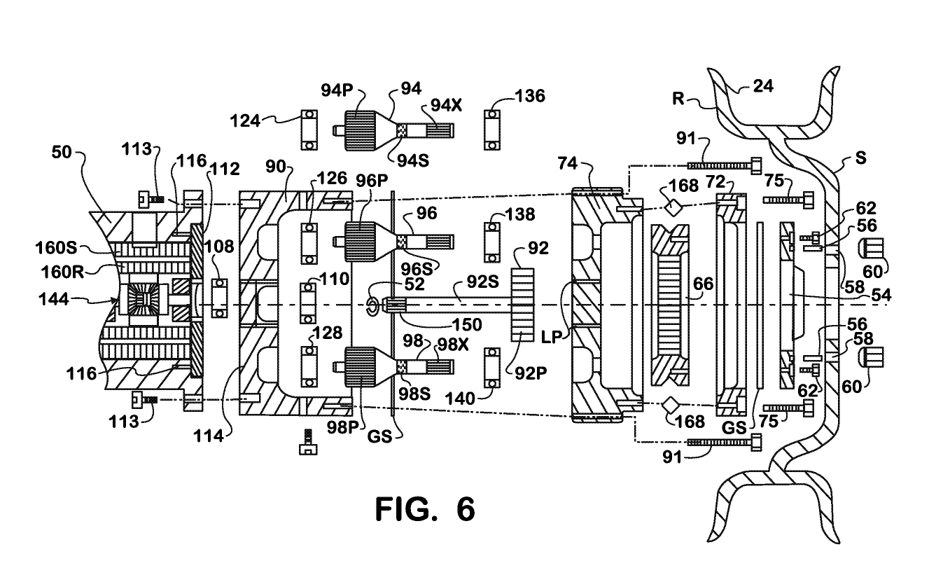

Each of the drive units that have been described are effective to rotate its road wheels with equal force, whilst allowing them to rotate at different speeds, mainly when a vehicle is turning corners. Moving internal parts are lubricated through a plurality of gasket-sealed lubrication passages in various casing parts and input shafts. Examples of such gasket-sealed lubrication passages LP and gaskets GS appear in FIGS. 5 and 6 where the passages are seen to communicate the interiors of the sun-planet gear cases with the central interior of the casing that contains the differential gear mechanism and the gaskets seal between confronting faces of casing parts. The shafts containing the planet gears have gasket-sealed lubrication passages open to the central interior of the casing, and at their opposite ends which are disposed in the ring gear cases, they are open so as to direct lubricant radially outwardly to the ring gear bearings. Passages can also provide leak-free lubrication fluid flow from the sun-planet gear cases back to the central interior of the casing containing the differential gear mechanism.

The motor of a drive unit may be not only electrical, but hydraulic, pneumatic, or any combination of two or more of the three types.

The disclosure has described a vehicle comprising a chassis having a left side and a right side, an outer left road wheel assembly on the left side of the chassis, an inner left road wheel assembly on the left side of the chassis inboard of the outer left road wheel assembly, an outer right road wheel assembly on the right side of the chassis, an inner right road wheel assembly on the right side of the chassis inboard of the outer right road wheel assembly, a left drive unit for driving the outer left road wheel assembly and the inner left road wheel assembly, a right drive unit for driving the outer right road wheel assembly and the inner right road wheel assembly, each drive unit comprising a respective carrier, a respective differential gear mechanism carried by the respective carrier, and a respective motor for rotating the respective carrier about a respective axis, each differential gear mechanism comprising a respective first spider gear on a respective first output shaft, a respective second spider gear on a respective second output shaft, a respective third spider gear, and a respective fourth spider gear, each third spider gear being meshed with both the first spider gear and the second spider gear of the respective differential gear mechanism, each fourth spider gear being meshed with both the first spider gear and the second spider gear of the respective differential gear mechanism, each third spider gear being freely rotatable on a respective first mounting shaft that is affixed to and rotates bodily with the respective carrier, each fourth spider gear being freely rotatable on a respective second mounting shaft that is affixed to and rotates bodily with the respective carrier, each drive unit comprising a respective outer gear train coupling the respective outer output shaft with the respective outer road wheel assembly and a respective inner gear train coupling the respective inner output shaft with the respective inner road wheel assembly.

The disclosure has described such a vehicle in which the respective motor of each drive unit comprises a respective rotor, and the respective rotor is coupled to the respective carrier by a respective spline coupling.

The disclosure has described such a vehicle in which each spline connection comprises an internal spline on the respective rotor and an external spline on the respective carrier.

The disclosure has described such a vehicle in which the internal spline of one of the drive units, the external spline of the one drive unit, the outer road wheel assembly of the one drive unit, and the inner road wheel assembly of the one drive unit rotate about a common axis.

The disclosure has described such a vehicle in which the internal spline of the other of the drive units, the external spline of the other of the drive units, the outer road wheel assembly of the other of the drive units, and the inner road wheel assembly of the other of the drive units rotate about an axis that is coincident with the common axis about which the internal spline of the one drive unit, the external spline of the one drive unit, the outer road wheel assembly of the one drive unit, and the inner road wheel assembly of the one drive unit rotate.

The disclosure has described such a vehicle in which each outer gear train comprises a respective outer sun gear on the respective outer output shaft spaced from the respective carrier, respective outer planet gears meshed with the respective outer sun gear, a respective outer ring gear meshed with the respective outer planet gears, a respective outer wheel mounting hub fastened to the respective outer ring gear, each inner gear train comprises a respective inner sun gear on the respective inner output shaft spaced from the respective carrier, respective inner planet gears meshed with the respective inner sun gear, a respective inner ring gear meshed with the respective inner planet gears, a respective inner wheel mounting hub fastened to the respective inner ring gear, the respective outer road wheel assembly is fastened to the respective outer wheel mounting hub, and the respective inner road wheel assembly is fastened to the respective inner wheel mounting hub.

The disclosure has described such a vehicle in which each drive unit comprises a respective casing that contains the respective carrier, the respective outer output shaft, the respective inner output shaft, the respective outer ring gear, and the respective inner ring gear, and each drive unit further comprises a respective outer main bearing assembly via which the respective outer ring gear can rotate on the respective casing and a respective inner main bearing assembly via which the respective inner ring gear can rotate on the respective casing.

The disclosure has described such a vehicle in which each casing comprises a respective pair of outer casing parts that are fastened together and comprise respective surfaces cooperatively defining a 90° groove that is circular about and faces the axis of the respective carrier and a respective pair of inner casing parts that are fastened together and comprise respective surfaces cooperatively defining a 90° groove that is circular about and faces the axis of the respective carrier, the respective outer main bearing assembly is retained on the casing by the parts of the respective pair of outer casing parts, the respective outer ring gear further comprises an outer circumference containing a 90° groove confronting the 90° groove defined by the parts of the respective pair of outer casing parts, the respective outer main bearing assembly further comprises cylindrical rollers disposed between the 90° groove in the respective outer ring gear and the 90° groove cooperatively defined by the parts of the respective pair of outer casing parts, the respective inner main bearing assembly is retained on the casing by the parts of the respective pair of inner casing parts, the respective inner ring gear further comprises an outer circumference containing a 90° groove confronting the 90° groove defined by the parts of the respective pair of inner casing parts, and the respective inner main bearing assembly further comprises cylindrical rollers disposed between the 90° groove in the respective inner ring gear and the 90° groove cooperatively defined by the parts of the respective pair of inner casing parts.

The disclosure has described such a vehicle in which each drive unit comprises a respective casing that contains the respective carrier, the respective outer output shaft, the respective inner output shaft, the respective outer gear train, the respective inner gear train, the respective outer ring gear, and the respective inner ring gear, and each casing comprises a succession of casing parts that can be disassembled from the respective drive unit to provide service access to the respective carrier, to the respective differential gear mechanism, and to the respective motor after the respective outer road wheel assembly has been removed from the respective drive unit while a further casing part that houses the respective carrier, the respective differential gear mechanism, and the respective motor remains with the chassis.

The disclosure has described such a vehicle in which each motor comprises an electric motor.

The disclosure has described such a vehicle further comprising a left steered road wheel assembly on the left side of the chassis forward of the outer left road wheel assembly and the inner left road wheel assembly and a right steered road wheel assembly on the right side of the chassis forward of the outer right road wheel assembly and the inner right road wheel assembly that are turned in unison to steer the chassis in a direction of travel.

The disclosure has also described an independent dual wheel tractor drive unit comprising a casing having an inner end, an outer end, and an internal drive mechanism, the internal drive mechanism comprising an inner wheel mounting hub at the inner end of the casing and an outer wheel mounting hub at the outer end of the casing, both of which wheel mounting hubs are supported for rotation about an axis, a motor for operating the internal drive mechanism to impart rotation to the wheel mounting hubs with equal force whilst allowing the wheel mounting hubs to rotate at different speeds, the internal drive mechanism further comprising a carrier that is disposed between the inner wheel mounting hub and the outer wheel mounting hub and that is rotated about the axis by the motor, and the carrier containing a differential gear mechanism having an inner output shaft for imparting rotation to the inner wheel mounting hub and an outer output shaft for imparting rotation to the outer wheel mounting hub.

The disclosure has described such an independent dual wheel tractor drive unit in which the differential gear mechanism comprises an outer spider gear on the outer output shaft and an inner spider gear on the inner output shaft and two additional spider gears each meshed with the inner spider gear and the outer spider gear, and a mounting for each additional spider gear on the carrier that causes each additional spider gear to bodily rotate with the carrier while leaving each additional spider gear to rotate about its own axis.

The disclosure has described such an independent dual wheel tractor drive unit in which the motor comprises a rotor that is coupled to the carrier by a spline coupling.

The disclosure has described such an independent dual wheel tractor drive unit in which the spline coupling comprises an internal spline on the rotor and an external spline on the carrier.

The disclosure has described such an independent dual wheel tractor drive unit in which an outer sun gear is disposed on the outer output shaft spaced from the carrier, outer planet gears are meshed with the outer sun gear, an outer ring gear is meshed with the outer planet gears, and the outer wheel mounting hub is fastened to the outer ring gear, and an inner sun gear is disposed on the inner output shaft spaced from the carrier, inner planet gears are meshed with the inner sun gear, an inner ring gear is meshed with the inner planet gears, and the inner wheel mounting hub is fastened to the inner ring gear.

The disclosure has described such an independent dual wheel tractor drive unit in which an inner main bearing assembly mounts the inner ring gear for rotation on the casing and an outer main bearing assembly mounts the outer ring gear for rotation on the casing.

The disclosure has described such an independent dual wheel tractor drive unit in which the casing comprises a pair of outer casing parts that are fastened together and comprise respective surfaces cooperatively defining a 90° groove that is circular about and faces the axis and a pair of inner casing parts that are fastened together and comprise respective surfaces cooperatively defining a 90° groove that is circular about and faces the axis, the outer main bearing assembly is retained on the casing by the parts of the pair of outer casing parts, the outer ring gear further comprises an outer circumference containing a 90° groove confronting the 90° groove defined by the parts of the pair of outer casing parts, the outer main bearing assembly further comprises cylindrical rollers disposed between the 90° groove in the outer ring gear and the 90° groove cooperatively defined by the parts of the pair of outer casing parts, the inner main bearing assembly is retained on the casing by the parts of the pair of inner casing parts, the inner ring gear further comprises an outer circumference containing a 90° groove confronting the 90° groove defined by the parts of the pair of inner casing parts, and the inner main bearing assembly further comprises cylindrical rollers disposed between the 90° groove in the inner ring gear and the 90° groove cooperatively defined by the parts of the pair of inner casing parts.

The disclosure has described such an independent dual wheel tractor drive unit in which the motor comprises an electric motor.

The disclosure has described such an independent dual wheel tractor drive unit further comprising an outer road wheel assembly disposed externally of the casing and fastened to an external face of the outer wheel mounting hub, and an inner road wheel assembly disposed externally of the casing and fastened to an external face of the inner wheel mounting hub.

What is claimed is:

1. A vehicle comprising:
a chassis having a left side and a right side;
an outer left road wheel assembly on the left side of the chassis and an inner left road wheel assembly on the left side of the chassis inboard of the outer left road wheel assembly;
an outer right road wheel assembly on the right side of the chassis and an inner right road wheel assembly on the right side of the chassis inboard of the outer right road wheel assembly;
a left drive unit for driving the outer left road wheel assembly and the inner left road wheel assembly;
a right drive unit for driving the outer right road wheel assembly and the inner right road wheel assembly;
each drive unit comprising a respective carrier, a respective differential gear mechanism carried by the respective carrier, and a respective motor for rotating the respective carrier about a respective axis;
each differential gear mechanism comprising a respective first spider gear on a respective first output shaft, a respective second spider gear on a respective second output shaft, a respective third spider gear, and a respective fourth spider gear;
each third spider gear being meshed with both the first spider gear and the second spider gear of the respective differential gear mechanism;
each fourth spider gear being meshed with both the first spider gear and the second spider gear of the respective differential gear mechanism; each third spider gear being freely rotatable on a respective first mounting shaft that is affixed to and rotates bodily with the respective carrier;
each fourth spider gear being freely rotatable on a respective second mounting shaft that is affixed to and rotates bodily with the respective carrier;
each drive unit comprising a respective outer gear train coupling the respective outer output shaft with the respective outer road wheel assembly and a respective inner gear train coupling the respective inner output shaft with the respective inner road wheel assembly.

2. A vehicle as set forth in claim 1 in which
the respective motor of each drive unit comprises a respective rotor, and
the respective rotor is coupled to the respective carrier by a respective spline coupling.

3. A vehicle as set forth in claim 2 in which each spline connection comprises an internal spline on the respective rotor and an external spline on the respective carrier.

4. A vehicle as set forth in claim 3 in which the internal spline of one of the drive units, the external spline of the one drive unit, the outer road wheel assembly of the one drive unit, and the inner road wheel assembly of the one drive unit rotate about a common axis.

5. A vehicle as set forth in claim 4 in which
the internal spline of the other of the drive units, the external spline of the other of the drive units, the outer road wheel assembly of the other of the drive units, and
the inner road wheel assembly of the other of the drive units rotate about an axis that is coincident with the common axis about which the internal spline of the one drive unit, the external spline of the one drive unit, the outer road wheel assembly of the one drive unit, and the inner road wheel assembly of the one drive unit rotate.

6. A vehicle as set forth in claim 1 in which
each outer gear train comprises a respective outer sun gear on the respective outer output shaft spaced from the respective carrier, respective outer planet gears meshed with the respective outer sun gear, a respective outer ring gear meshed with the respective outer planet gears, a respective outer wheel mounting hub fastened to the respective outer ring gear,
each inner gear train comprises a respective inner sun gear on the respective inner output shaft spaced from the respective carrier, respective inner planet gears meshed with the respective inner sun gear, a respective inner ring gear meshed with the respective inner planet gears, a respective inner wheel mounting hub fastened to the respective inner ring gear,
the respective outer road wheel assembly is fastened to the respective outer wheel mounting hub, and
the respective inner road wheel assembly is fastened to the respective inner wheel mounting hub.

7. A vehicle as set forth in claim 6 in which
each drive unit comprises a respective casing that contains the respective carrier, the respective outer output shaft, the respective inner output shaft, the respective outer gear train, the respective inner gear train, the respective outer ring gear, and the respective inner ring gear, and
each drive unit further comprises a respective outer main bearing assembly via which the respective outer ring gear can rotate on the respective casing and a respective inner main bearing assembly via which the respective inner ring gear can rotate on the respective casing.

8. A vehicle as set forth in claim 7 in which
each casing comprises a respective pair of outer casing parts that are fastened together and comprise respective surfaces cooperatively defining a 90° groove that is circular about and faces the axis of the respective carrier and a respective pair of inner casing parts that are fastened together and comprise respective surfaces cooperatively defining a 90° groove that is circular about and faces the axis of the respective carrier,
the respective outer main bearing assembly is retained on the casing by the parts of the respective pair of outer casing parts,
the respective outer ring gear further comprises an outer circumference containing a 90° groove confronting the 90° groove defined by the parts of the respective pair of outer casing parts,
the respective outer main bearing assembly further comprises cylindrical rollers disposed between the 90° groove in the respective outer ring gear and the 90° groove cooperatively defined by the parts of the respective pair of outer casing parts,
the respective inner main bearing assembly is retained on the casing by the parts of the respective pair of inner casing parts,
the respective inner ring gear further comprises an outer circumference containing a 90° groove confronting the 90° groove defined by the parts of the respective pair of inner casing parts, and
the respective inner main bearing assembly further comprises cylindrical rollers disposed between the 90° groove in the respective inner ring gear and the 90° groove cooperatively defined by the parts of the respective pair of inner casing parts.

9. A vehicle as set forth in claim 1 in which
each drive unit comprises a respective casing that contains the respective carrier, the respective outer output shaft, the respective inner output shaft, the respective outer gear train, the respective inner gear train, the respective outer ring gear, and the respective inner ring gear, and
each casing comprises a succession of casing parts that can be disassembled from the respective drive unit to provide service access to the respective carrier, to the respective differential gear mechanism, and to the respective motor after the respective outer road wheel assembly has been removed from the respective drive unit while a further casing part that houses the respective carrier, the respective differential gear mechanism, and the respective motor remains with the chassis.

10. A vehicle as set forth in claim 1 in which each motor comprises an electric motor.

11. A vehicle as set forth in claim 1 further comprising a left steered road wheel assembly on the left side of the chassis forward of the outer left road wheel assembly and the inner left road wheel assembly and a right steered road wheel assembly on the right side of the chassis forward of the outer right road wheel assembly and the inner right road wheel assembly that are turned in unison to steer the chassis in a direction of travel.

12. An independent dual wheel tractor drive unit comprising:
a casing having an inner end, an outer end, and an internal drive mechanism,
the internal drive mechanism comprising an inner wheel mounting hub at the inner end of the casing and an outer wheel mounting hub at the outer end of the casing, both of which wheel mounting hubs are supported for rotation about an axis,
a motor for operating the internal drive mechanism to impart rotation to the wheel mounting hubs with equal force whilst allowing the wheel mounting hubs to rotate at different speeds,
the internal drive mechanism further comprising a carrier that is disposed between the inner wheel mounting hub and the outer wheel mounting hub and that is rotated about the axis by the motor, and
the carrier containing a differential gear mechanism having an inner output shaft for imparting rotation to the inner wheel mounting hub and an outer output shaft for imparting rotation to the outer wheel mounting hub.

13. An independent dual wheel tractor drive unit as set forth in claim 12 in which the differential gear mechanism comprises an outer spider gear on the outer output shaft and an inner spider gear on the inner output shaft and two additional spider gears each meshed with the inner spider gear and the outer spider gear, and a mounting for each additional spider gear on the carrier that causes each additional spider gear to bodily rotate with the carrier while leaving each additional spider gear to rotate about its own axis.

14. An independent dual wheel tractor drive unit as set forth in claim 13 in which the motor comprises a rotor that is coupled to the carrier by a spline coupling.

15. An independent dual wheel tractor drive unit as set forth in claim 14 in which the spline coupling comprises an internal spline on the rotor and an external spline on the carrier.

16. An independent dual wheel tractor drive unit as set forth in claim 13 in which
an outer sun gear is disposed on the outer output shaft spaced from the carrier, outer planet gears are meshed with the outer sun gear, an outer ring gear is meshed with the outer planet gears, and the outer wheel mounting hub is fastened to the outer ring gear, and
an inner sun gear is disposed on the inner output shaft spaced from the carrier, inner planet gears are meshed with the inner sun gear, an inner ring gear is meshed with the inner planet gears, and the inner wheel mounting hub is fastened to the inner ring gear.

17. An independent dual wheel tractor drive unit as set forth in claim 16 in which an inner main bearing assembly mounts the inner ring gear for rotation on the casing and an outer main bearing assembly mounts the outer ring gear for rotation on the casing.

18. An independent dual wheel tractor drive unit as set forth in claim 17 in which
the casing comprises a pair of outer casing parts that are fastened together and comprise respective surfaces cooperatively defining a 90° groove that is circular about and faces the axis and a pair of inner casing parts that are fastened together and comprise respective surfaces cooperatively defining a 90° groove that is circular about and faces the axis,
the outer main bearing assembly is retained on the casing by the parts of the pair of outer casing parts,
the outer ring gear further comprises an outer circumference containing a 90° groove confronting the 90° groove defined by the parts of the pair of outer casing parts,
the outer main bearing assembly further comprises cylindrical rollers disposed between the 90° groove in the outer ring gear and the 90° groove cooperatively defined by the parts of the pair of outer casing parts,
the inner main bearing assembly is retained on the casing by the parts of the pair of inner casing parts,
the inner ring gear further comprises an outer circumference containing a 90° groove confronting the 90° groove defined by the parts of the pair of inner casing parts, and
the inner main bearing assembly further comprises cylindrical rollers disposed between the 90° groove in the inner ring gear and the 90° groove cooperatively defined by the parts of the pair of inner casing parts.

19. An independent dual wheel tractor drive unit as set forth in claim 12 in which the motor comprises an electric motor.

20. An independent dual wheel tractor drive unit as set forth in claim 12 further comprising an outer road wheel assembly disposed externally of the casing and fastened to an external face of the outer wheel mounting hub, and an inner road wheel assembly disposed externally of the casing and fastened to an external face of the inner wheel mounting hub.
